(19) United States
(12) Patent Application Publication
(10) Pub. No.: US 2026/0353000 A1
(43) Pub. Date: Nov. 5, 2026

(54) DEVICE AND METHOD FOR CONTROLLING VOLUMES, AT A SPEAKER, OF TRACKS PLAYED BY APPLICATIONS DIFFERENT FROM A HIGHEST PRIORITY APPLICATION

(71) Applicant: MOTOROLA SOLUTIONS, INC., Chicago, IL (US)

(72) Inventors: Ibrahim Mohammed Adnan MOHAMMED, Penang (MY); Moh Lim SIM, Bayan Lepas (MY); Keh Yong TEH, Ayer Itam (MY); Teik Seng SAW, Sungai Petani (MY); Ondy Dharma Indra SUKMA, Medan (ID); Chi Ning LAI, Nibong Tebal (MY)

(21) Appl. No.: 19/194,490

(22) Filed: Apr. 30, 2025

(51) Int. Cl. H04R 3/00

(52) U.S. Cl. CPC H04R 3/00; H04R 2420/01; H04R 2430/01

(57) ABSTRACT

A device and method are provided for controlling volumes at a speaker of tracks played by applications different from a highest priority application. A computing device maintains: respective priorities of applications configured to play tracks; and volume control policies of volumes associated with different track types playable by the applications, the volume control policies associated with the respective priorities of the applications. When a given application plays a given track, the computing device: determines an associated volume control policy associated with a respective priority of a highest priority application that is presently playing a respective track; and controls via a speaker, respective volumes of any respective tracks presently being played by applications different from the highest priority application, based on the associated volume control policy, the respective volumes controlled on a per track-type basis.

### BACKGROUND OF THE INVENTION

Mobile devices generally support multiple concurrent applications with audio output requirements. In mission-critical environments, such as public safety environments, audio output from mission-critical applications needs to be provided without audio interference, but when audio from other applications is output, such audio may override and/or mask the audio output from the mission-critical applications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a device for controlling volumes at a speaker of tracks played by applications different from a highest priority application, in accordance with some examples.

FIG. 2 is a device diagram showing a device structure of the device of FIG. 1, in accordance with some examples.

FIG. 3 is a flowchart of a process for controlling volumes at a speaker of tracks played by applications different from a highest priority application, in accordance with some examples.

FIG. 4 depicts the device of FIG. 2 implementing aspects of a process for controlling volumes at a speaker of tracks played by applications different from a highest priority application, in accordance with some examples.

FIG. 5 depicts the device of FIG. 2 implementing further aspects of a process for controlling volumes at a speaker of tracks played by applications different from a highest priority application, in accordance with some examples.

FIG. 6 depicts the device of FIG. 2 implementing further aspects of a process for controlling volumes at a speaker of tracks played by applications different from a highest priority application, in accordance with some examples.

FIG. 7 depicts the device of FIG. 2 implementing further aspects of a process for controlling volumes at a speaker of tracks played by applications different from a highest priority application, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Generally, conventional mobile operating systems, such as Android™, implement volume management that all audio tracks of a given type (e.g., media, notification, voice call), are adjusted together and/or universally. Put another way, adjusting the volume for one application affects all applications using a same audio track-type. This limitation poses significant challenges when mission-critical applications must coexist with other audio-generating applications, such as VOIP applications, media applications, notification applications, and the like. Furthermore, such operating system's volume control application programming interfaces (APIs) do not support real-time fine-gain control over audio tracks originating from external applications.

Accordingly, there exists a need for an improved technical method, device, and system for controlling volumes at a speaker of tracks played by applications different from a highest priority application.

A first aspect of the present specification provides a method comprising: maintaining, via a computing device, respective priorities of applications configured to play tracks; maintaining, via the computing device, volume control policies of volumes associated with different track types playable by the applications, the volume control policies associated with the respective priorities of the applications; and when a given application plays a given track: determining, via the computing device, an associated volume control policy associated with a respective priority of a highest priority application that is presently playing a respective track; and controlling, via the computing device, and via a speaker, respective volumes of any respective tracks presently being played by applications different from the highest priority application, based on the associated volume control policy, the respective volumes controlled on a per track-type basis.

A second aspect of the present specification provides a computing device comprising: a speaker; a controller; and a computer-readable storage medium having stored thereon program instructions that, when executed by the controller, causes the controller to perform a set of operations comprising: maintaining respective priorities of applications configured to play tracks; maintaining volume control policies of volumes associated with different track types playable by the applications, the volume control policies associated with the respective priorities of the applications; and when a given application plays a given track: determining an associated volume control policy associated with a respective priority of a highest priority application that is presently playing a respective track; and controlling, via the speaker, respective volumes of any respective tracks presently being played by applications different from the highest priority application, based on the associated volume control policy, the respective volumes controlled on a per track-type basis.

Each of the above-mentioned aspects will be discussed in more detail below, starting with example system and device architectures of the system, in which the embodiments may be practiced, followed by an illustration of processing blocks for achieving an improved technical method, device, and system for controlling volumes at a speaker of tracks played by applications different from a highest priority application.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

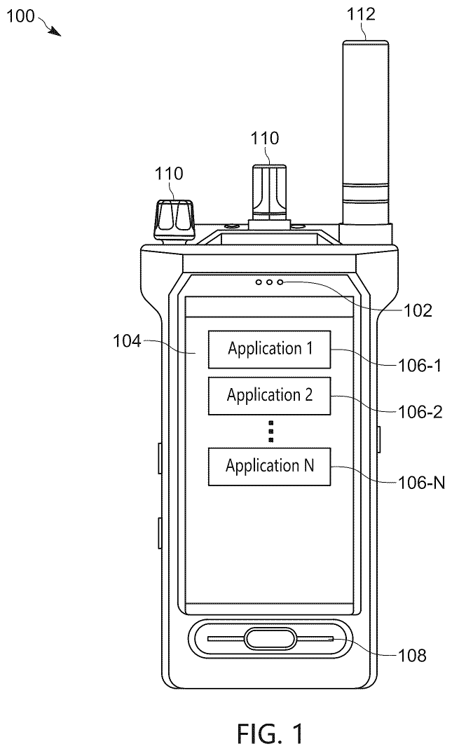

Attention is directed to FIG. 1, which depicts a device 100 for controlling volumes, at a speaker, of tracks played by applications different from a highest priority application, in accordance with present examples. The various components of the device 100 are communicatively coupled and/or in communication via any suitable combination of communication links, and communication links between components of the device 100 are depicted throughout the present specification, as double-ended arrows between respective components.

As depicted, the device 100 comprises a communication device for first responders and/or public-safety officers (e.g., police, firefighters, emergency medical technicians, security personal, and the like), such as a land-mobile radio (LMR), digital mobile radio (DMR), and the like. However, the device 100 may comprise any suitable combination of a computing device and/or communication device configured to play audio tracks (e.g., hereafter tracks) from different applications being processed by the device 100.

For example, as depicted, the device 100 comprises a speaker 102 and a display screen 104. The display screen 104 may comprise a touch screen display.

Also as depicted at the display screen 104, the device 100 is processing a plurality of applications 106-1, 106-2 . . . 106-N, where “N’ is any suitable integer number greater than “1”, and the applications 106-1, 106-2 . . . 106-N may be hereafter interchangeably referred to, collectively as the applications 106 and, generically, as an application 106.

While the applications 106 are all shown as active and/or operating, as well as accessible via the display screen 104, one or more of the applications 106 may be inactive at any given time, and/or may not be active until selected via an input device of the device 100 (e.g., including, but not limited to, the aforementioned touch screen display).

The applications 106 may be of any suitable type that may utilize the speaker 102 to play tracks of any suitable type, and may include, but are not limited to, LMR and/or voice applications (e.g., for playing LMR voice tracks, and the like), mission-critical applications (e.g., for playing) , mission-critical voice tracks, and the like), VOIP applications, notification applications, media applications, and the like, amongst other possibilities. For example, an applications 106 may include a text-to-speech application.

As used herein, the term “mission-critical application” is understood to refer to an application for a first responder communication device (e.g., such as the device 100) the application comprising a software component that has been defined as essential for ensuring reliable, secure, and real-time communication in emergency and life-threatening situations. Such applications may operate on dedicated or prioritized wireless networks and are configured to meet stringent requirements for availability, low latency, fault tolerance, and interoperability with other public safety systems. Typical functionality of such mission-critical applications may include, but are not limited to, one or more of: push-to-talk (PTT) applications, LMR applications, emergency alert and/or communication applications, group communication applications, and the like. However, mission-critical applications are understood to include functionality for receiving and playing audio. Failure or unavailability of a mission-critical application (e.g., including, but not limited to, masking, obscuring, overriding and/or interfering of audio from a mission-critical application), may result in loss of situational awareness, delayed response times, or compromised safety for first responders and/or the public.

Furthermore, as used herein, the term “track” and/or “audio track” is understood to refer to any suitable audio played by an application 106, and may include, but is not limited to, voice tracks (e.g., received at the device 100 in mission-critical and/or LMR audio stream), VOIP (voice over internet protocol) tracks (e.g., received at the device 100 in a VOIP audio stream), media tracks, notification tracks, text-to-speech tracks (e.g., text messages converted to speech), and the like. In present examples, four track types will be used as examples: media tracks, voice tracks, VOIP tracks, and “other” tracks. Such other tracks are understood to include any tracks that are not media tracks, voice tracks, and VOIP tracks, including, but limited to, text-to-speech tracks.

At least one of the applications 106 may be considered “mission critical” applications. Indeed, hereafter, the term mission-critical application 106 is understood to refer to any of the applications 106 that has been designated as mission-critical (e.g., by an administer of as system of which the device 100 is a component) and may include, but is not limited to, a PTT application, an LMR application, and the like. In particular, such a mission-critical application 106 may be used to provide audio, at the speaker 102, received at the device 100 during an incident, such as a public safety incident, and the like. Put another way, an operator of the device 100 may be speaking with an operator of another (e.g., similar) device, to discuss an ongoing public safety incident. However, if VOIP audio is received while the audio from the mission-critical application 106 is being provided at the speaker 102, a VOIP application 106 may play the VOIP audio at the speaker 102, obscuring the audio from the mission-critical application 106. As both tracks output at the speaker 102 are voice/speech, a universal control of voice/speech audio at the device 100 would only result in both tracks (e.g., audio from the mission-critical application 106 and audio from the VOIP application 106) being lowered or raised concurrently.

As such, the device 100 is generally configured to: maintain respective priorities of the applications 106 configured to play tracks; maintain volume control policies of volumes associated with different track types playable by the applications 106, the volume control policies associated with the respective priorities of the applications; and when a given application 106 plays a given track: determine an associated volume control policy associated with a respective priority of a highest priority application 106 that is presently playing a respective track; and control, via the speaker 102, respective volumes of any respective tracks presently being played by applications 106 different from the highest priority application 106, based on the associated volume control policy, the respective volumes controlled on a per track-type basis. Such functionality will be described in more detail herein.

For completeness, and with further reference to FIG. 1, it is understood that, as depicted, the device 100 further comprises a microphone 108, one or more knobs 110 for controlling aspects of a mission-critical application 106, and the like (e.g., such a talkgroup selection) an antenna 112, and/or any other suitable components for conducting radio communications, and the like.

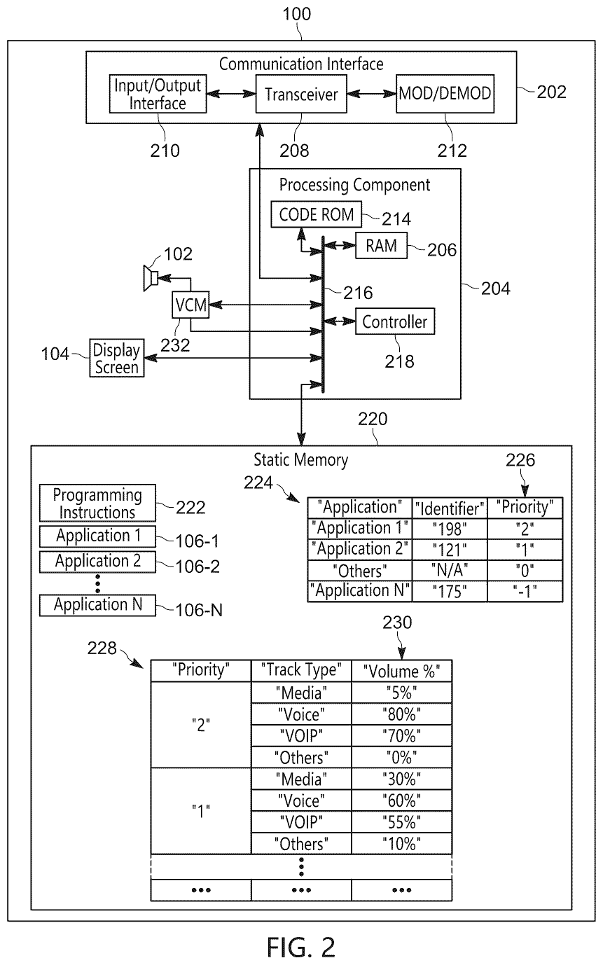

Attention is next directed to FIG. 2, which depicts a schematic block diagram of an example of the device 100. While the device 100 is depicted in FIG. 2 as a single component, functionality of the device 100 may be distributed among a plurality of components and the like including, but not limited to, any suitable combination of one or more servers, one or more cloud computing devices, and the like. Hence, for example, while the device 100 is described herein as comprising an LMR device, the device 100 may be implemented in a network, and the device 100 may control the speaker 102 located, for example, at a terminal (e.g., of a public safety answering point, and the like) with the device 100 implementing the applications 106 on behalf of the terminal, and the like.

As depicted, the device 100 comprises: a communication interface 202, a processing component 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a controller 218, and a static memory 220 storing at least one set of programming instructions 222. Furthermore, while the memories 206, 214 are depicted as having a particular structure and/or configuration, (e.g., separate RAM 206 and ROM 214), memory of the device 100 may have any suitable structure and/or configuration.

The device 100, as depicted, further comprises the speaker 102, the display screen 104 (and/or any other suitable notification device), the microphone 108, one or more input devices (e.g., with brief reference to FIG. 1, such as the touch screen display of the display screen 104, the knobs 110, and the like). However, the device 100 may comprise any suitable set of components and/or the speaker 102, the display screen 104 (and/or any other suitable notification device), the microphone 108, one or more input devices may be external to the device 100, such as when the device 100 implementing the applications 106 on behalf of a terminal.

Hence, while the speaker 102, the display screen 104, the microphone 108, and are depicted as components of the device 100, in other examples, such components, and/or any other suitable component, maybe be external to the device 100, and communicatively coupled to the device 100.

As shown in FIG. 2, the device 100 includes the communication interface 202 communicatively coupled to the common data and address bus 216 of the processing component 204.

The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other devices (not depicted) of a system of which the device 100 is a component. For example, the communication interface 202 may include one or more wired and/or wireless transceivers 208 for communicating with other suitable components of a system of which the device 100 is a component. Hence, the one or more transceivers 208 may be adapted for communication with one or more communication links and/or communication networks used to communicate with the other suitable components of a system of which the device 100 is a component. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that the DMR transceivers, P25 transceivers, and TETRA transceivers may be particular to first responder devices, and hence such transceivers may be present when the device 100 comprises a first responder device, and the like.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the device 100.

The controller 218 may be implemented as a plurality of processors, one or more multi-core processors, or specialized hardware accelerators such as Graphics Processing Units (GPUs), Tensor Processing Units (TPUs), or similar parallel processing units optimized for handling large-scale data and complex machine learning models. The controller 218 is hence configured to execute different programming instructions and/or programming code; alternatively, or in addition, the controller 218 may include one or more ASIC (application-specific integrated circuits) and one or more FPGA (field-programmable gate arrays), and/or another electronic device.

In some examples, the controller 218 and/or the device 100 is not a generic controller and/or a generic device, but a device specifically configured to implement functionality for controlling volumes at a speaker of tracks played by applications different from a highest priority application. For example, in some examples, the device 100 and/or the controller 218 specifically comprises a computer executable engine configured to implement functionality for controlling volumes at a speaker of tracks played by applications different from a highest priority application.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, the programming instructions 222 (e.g., machine readable instructions) that implement the functionality of the device 100 as described herein are maintained, persistently, at the memory 220 and used by the controller 218, which makes appropriate utilization of volatile storage during the execution of such programming instructions 222.

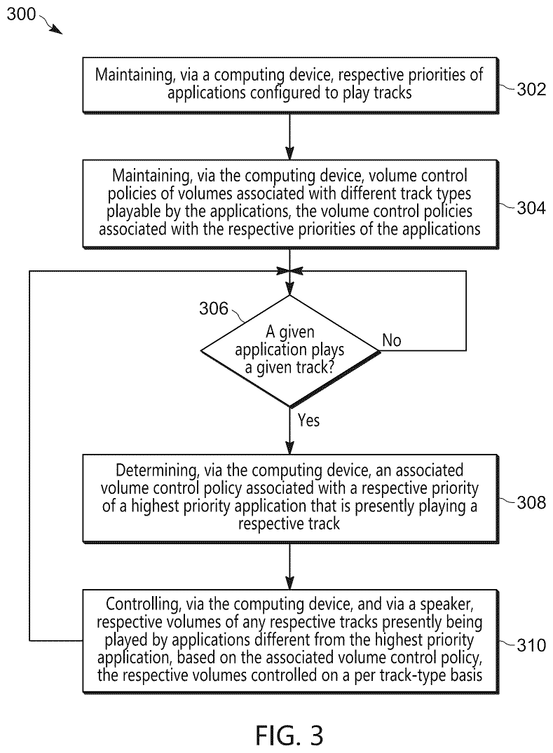

Regardless, it is understood that the memory 220 stores programming instructions 222 that, when executed by the controller 218, enables the controller 218 to implement functionality for controlling volumes at a speaker of tracks played by applications different from a highest priority application, including, but not limited to, the blocks of the process set forth in FIG. 3.

Also depicted in FIG. 2, the applications 106 are stored at the memory 220, and, in particular, it is understood that the applications 106 as stored at the memory 220 represent respective programming instructions that, when implemented by the controller 218, cause the functionality of the applications 106 to be implemented. It is further understood that functionality of the programming instructions 222 are separate from the functionality of the applications 106, such that the programming instructions 222 may be used to control volume of tracks played by the applications 106 via the speaker 102. Indeed, the programming instructions 222, when implemented by the controller 218 may control such tracks on a per-track-type basis using, for example, a priority database 224, which stores respective priorities 226 of the applications 106, and a volume database 228, which stores volume control policies 230 as described herein. While the priorities 226 and the volume control policies 230 are described as stored in respective databases 224, 228, it is understood that the priorities 226 and the volume control policies 230 may be stored in any suitable format, such as one or more lookup tables, and the like.

As depicted, the priority database 224 is provided in a tabular format, with a first column listing textual descriptions of respective applications 106 and, in particular, “Application 1”, “Application 2”, “Others”, and “Application N”, and the like. “Application 1” is understood to refer to a first application 106-1, “Application 2” is understood to refer to a second application 106-2, and “Application N” is understood to refer to an Nth application 106-N. The term “Others” is understood to refer to all other applications 106.

The second column of the priority database 224 lists alphanumeric identifiers of respective applications 106, with the identifiers understood to be unique to the respective applications 106 at the device 100. For example, when an application 106 is installed at the device 100, the device 100 may be configured to assign a respective unique identifier thereto that is different from other identifiers already assigned to applications 106. As depicted, the first application 106-1 (e.g., “Application 1”) is assigned an identifier “198”, the second application 106-2 (e.g., “Application 2”) is assigned an identifier “121”, and the N^{th} application 106-N (e.g., “Application N”) is assigned an identifier “175”.

It is understood that the “Other” applications 106 may comprise any suitable number of other applications 106 and may not have respective identifiers, and hence the second column lists “N/A” (e.g., not applicable). Alternatively, the other applications 106 may have respective identifiers, but such identifiers may or may not (as depicted) be listed in the second column.

The third column of the priority database 224 lists respective priorities 226 of the applications 106. For example the first application 106-1 is associated with a priority of “2”, the second application 106-2 is associated with a priority of “1”, the other applications 106 are associated with a priority of “0”, and the Nth application 106-N is associated with a priority of “−1”. It is understood that, in the depicted scheme, the higher the numerical priority, the higher the priority of an associated application 106. Hence, the first application 106-1 has a higher priority than the second application 106-2, the second application 106-2 has a higher priority than the other applications 106, and the other applications 106 have a higher priority than the Nth application 106-N. However, any suitable priority scheme is within the scope of the present specification. Furthermore, while only four numerical priorities are shown in present examples, the respective priorities 226 may include any suitable number of numerical priorities.

It is further understood that the respective priorities 226 may be received via an input device, such that an operator of the device 100 may set the respective priorities 226, for example via a graphic user interface (GUI) provided at the display screen 104.

Alternatively, or in addition, the respective priorities 226 of the applications 106 may be set automatically by an administrator of a system of which the device 100 is a component. In particular, the device 100 may be preconfigured with indicators of types of applications 106 and respective priorities 226 thereof, for example as set by an administrator of a system of which the device 100 is a component, and the device 100 may set the respective priorities 226 of applications 106, when installed, according to such indicators.

Alternatively, or in addition, when an application 106 is installed, the device 100 may control the display screen 104 to provide a GUI, and the like, to request, from an operator of the device 100, a respective priority 226 of the application 106 being installed; when no respective priority 226 is received, the device 100 may automatically set the respective priority 226 according to the indicators. Alternatively, or in addition, one or more of applications 106 may configured to use an Application Programming Interface (API) to programmatically configure a respective priority 226.

Furthermore, different application types may have default respective priorities 226 and an operator of the device 100 may change and/or edit such priorities 226. In some examples, default respective priorities 226 may be “0” such that any application 106 that is not assigned a priority 226 by an operator is categorized as an “Other” application 106.

It is further understood, however, that only one application 106 may be assigned a highest priority 226, for example to prevent collisions in volume control. Put another way, only one application 106 (e.g., in FIG. 2, the first application 106-1) may have a highest priority 226 (e.g., of “2”) so that respective volume control policies (described hereafter) do not collide. In such examples, the application 106 assigned the highest priority 226 may be determined from the aforementioned indicators. For example, when the device 100 comprises a first responder device, an LMR application 106 and/or a designated mission-critical application 106 may be automatically selected as the highest priority application 106.

It is further understood that an application 106 assigned a highest priority 226 may be different from a highest priority application 106, of applications 106 that are currently playing tracks.

For example, while in FIG. 2 the first application 106-1 is assigned a highest priority 226, when the first application 106-1 is not currently playing a track, and the second application 106-2 is currently playing a track, the second application 106-2 may be a highest priority application 106. However, when the first application 106-1 is currently playing a track, the first application 106-1 may be a highest priority application 106.

Turning now to the volume database 228, the volume database 228 may also be provided in a tabular format, organized by numerical priority, track type and associated volume control policies 230.

Hence, for example, the priority 226 of “2” is associated with the track types “Media”, “Voice”, “VOIP” and “Others” and the respective volume control policies 230 for these track types include indications of changes in volumes of such track types, in percentages, relative to a maximum volume and/or 100% volume (though hereafter the term maximum volume will be used for simplicity).

It is understood that a maximum volume may comprise a volume to which a given track type may initially be set, for example, via one or more volume control buttons, and the like, at the device 100, and such one or more volume control buttons may control volume at an audio stream level (e.g., media, notification, voice call), where adjusting the volume for one application affects all applications using the same stream type.

In the depicted example: for the priority 226 of “2” and a track type of “Media”, the respective volume control policy 230 has a value of “5%”; a track type of “Voice” has a respective volume control policy 230 of a value of “80%”; a track type of “VOIP” has a respective volume control policy 230 of a value of “70%”; and a track type of “Others” has a respective volume control policy 230 of a value of “0%”.

Similarly, for the priority of “1”: for a track type of “Media”, the respective volume control policy 230 has a value of “30%”; a track type of “Voice” has a respective volume control policy 230 of a value of “60%”; a track type of “VOIP” has a respective volume control policy 230 of a value of “55%”; and a track type of “Others” has a respective volume control policy 230 of a value of “10%”.

While for simplicity the volume control policies 230 of only two priorities 226 are shown, the volume database 228 may include respective volume control policies 230 for the priorities 226 listed in the priority database 224, as indicated by ellipses in the volume database 228.

It is further understood that the volume control policies 230, and/or at least the values thereof, may be received via an input device, such that an operator of the device 100 may set the volume control policies 230 via a GUI, and the like. Alternatively, or in addition, the volume control policies 230 of the applications 106 may be set automatically by an administrator of a system of which the device 100 is a component. Indeed, in some examples, the volume control policies 230 may all be set to default values (e.g., “Media” tracks at 20%, “Voice” tracks at “80%”, “VOIP” tracks at “50%”, and “Other” tracks at “10%”, amongst other possibilities), until changed by an operator of the device 100. It is understood that the operator of the device 100 may also set the default values.

As depicted, the device 100 further comprises a volume control module (VCM) 232, communicatively coupled with the controller 218. The VCM 232 is generally configured to control volume of individual tracks provided to the speaker 102. As such, the VCM 232 is depicted as being located on a communication link between the controller 218 and the speaker 102. The VCM 232 may comprise any suitable combination of software and hardware configured to control volume of individual tracks provided to the speaker 102, as controlled by the controller 218. The VCM 232 may, in some instances, comprise an audio mixer configured to receive a plurality of audio tracks, and control relative volume of the audio tracks.

For example, the VCM 232 (e.g., an audio mixer) may be configured to reduce a volume of a particular track according to a volume control policy 230, such as reduce a media track to “5%” of a maximum volume (e.g., according to the volume control policy 230 for a priority of “2” for a “Media” track). The VCM 232 may be further configured to increase a volume of a particular track, for example back to a maximum volume, such as increase the volume of the media track from “5%” back to the maximum volume. Furthermore, the VCM 232 may decrease and increase volume of particular tracks independent of other tracks, such that volume of any tracks being provided to the speaker 102 may be controlled independent of each other.

Furthermore, while a specific location of the VCM 232 is depicted at the device 100, the VCM 232, and the like, may be provided in any suitable manner at the device 100, including, but not limited to, a software module being implemented by the controller 218 and/or as a software module of the programming instructions 222.

Use of the respective priorities 226 and the volume control policies 230 are next described with respect to FIG. 3.

Attention is now directed to FIG. 3, which depicts a flowchart representative of a process 300 for controlling volumes at a speaker of tracks played by applications different from a highest priority application. The operations of the process 300 of FIG. 3 correspond to machine readable instructions that are executed by the device 100, and specifically the controller 218 of the device 100. In the illustrated example, the instructions represented by the blocks of FIG. 3 are stored at the memory 220 for example, as the programming instructions 222. The process 300 of FIG. 3 is one way that the controller 218 and/or the device 100 and/or the device 100 may be configured. Furthermore, the following discussion of the process 300 of FIG. 3 will lead to a further understanding of the device 100, and its various components.

The process 300 of FIG. 3 need not be performed in the exact sequence as shown and likewise various blocks may be performed in parallel rather than in sequence. Accordingly, the elements of process 300 are referred to herein as “blocks” rather than “steps.” The process 300 of FIG. 3 may be implemented on variations of the device 100 of FIG. 1, as well.

At a block 302, the controller 218, and/or the device 100, maintains respective priorities 226 of applications 106 configured to play tracks.

The respective priorities 226 of the applications 106 may be maintained in the priority database 224.

Furthermore, maintaining, at the block 302, the respective priorities 226 of the applications 106 may comprise: receiving, via an input device, the respective priorities 226 of the applications 106; and storing the respective priorities 226 of the applications 106. For example, as has been described, an operator of the device 100 may use an input device, such as a touch screen display, to change and/or assign the respective priorities 226 of the applications 106.

Alternatively, or in addition, maintaining, at the block 302, the respective priorities 226 of the applications 106 may comprise: assigning a given priority 226 to the applications 106 for which a respective priority 226 is not received via the input device. Hence, an application 106 may be automatically assigned a respective priority 226 when such a priority 226 is not otherwise assigned via an input device.

At a block 304, the controller 218, and/or the device 100, maintains volume control policies 230 of volumes associated with different track types playable by the applications 106, the volume control policies 230 associated with the respective priorities 226 of the applications 106.

The volume control policies 230 may be maintained in the volume database 228 on a per-track-type basis.

Furthermore, maintaining the volume control policies 230 of the volumes associated with the different track types playable by the applications 106 may comprise: receiving, via an input device (e.g., the touch screen display), respective relative volumes of the different track types; and storing the respective relative volumes.

At a block 306, the controller 218, and/or the device 100 monitors the applications 106 to determine when a given application 106 plays a given track.

When a given application 106 plays a given track (e.g., a “YES” decision at the block 306), at a block 308, the controller 218, and/or the device 100 determines an associated volume control policy 230 associated with a respective priority 226 of a highest priority application 106 that is presently playing a respective track.

At a block 310, the controller 218, and/or the device 100, controls via the speaker 102, respective volumes of any respective tracks presently being played by applications 106 different from the highest priority application 106, based on the associated volume control policy 230, the respective volumes controlled on a per track-type basis.

Hence, for example, when a given track is played by a given application 106, the controller 218, and/or the device, determines which application 106, of applications 106 that are currently playing tracks, has a highest priority 226, according to the respective priorities 226. Such a highest priority application 106 may hence depend on which of the applications 106 are presently playing tracks (e.g., regardless of type). Such a highest priority application 106 may be the application 106 assigned the highest priority 226 of “2”, or another application 106 (e.g., when the application 106 assigned the highest priority 226 of “2” is not playing tracks).

Having determined respective priorities 226 of the applications 106 that are currently playing tracks, the highest priority 226, of such respective priorities 226, is selected and the associated volume control policies 230 of that highest priority 226 may be selected from the volume database 228, and the like. Tracks being played by applications 106 that are different from the application 106 that has a highest priority 226 are then controlled according to the selected associated volume control policies 230.

However, determining the associated volume control policy 230, associated with the respective priority 226 of the highest priority application 106 that is presently playing the respective track, may comprise: determining respective priorities 226 of the given track and any of the respective tracks being played by respective applications 106. In particular, the respective priorities 226 of the given track and the respective tracks may be determined based on associated priorities 226 of the given application 106 and the respective applications 106 presently playing tracks.

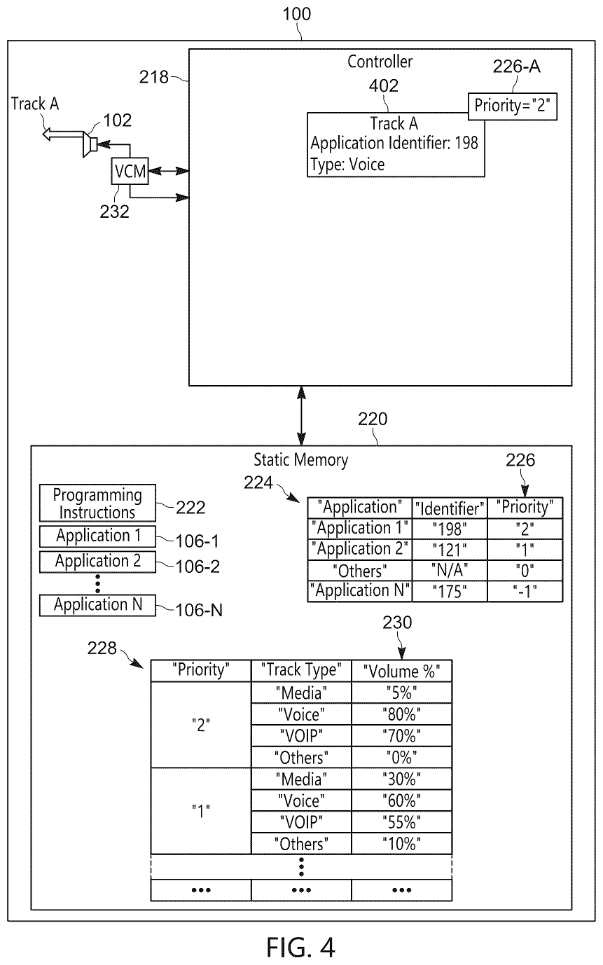

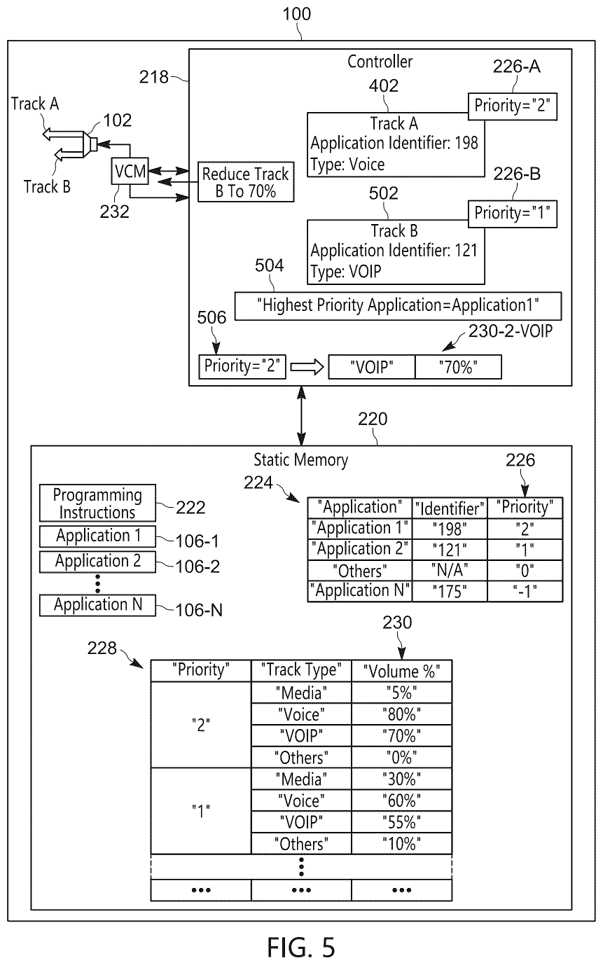

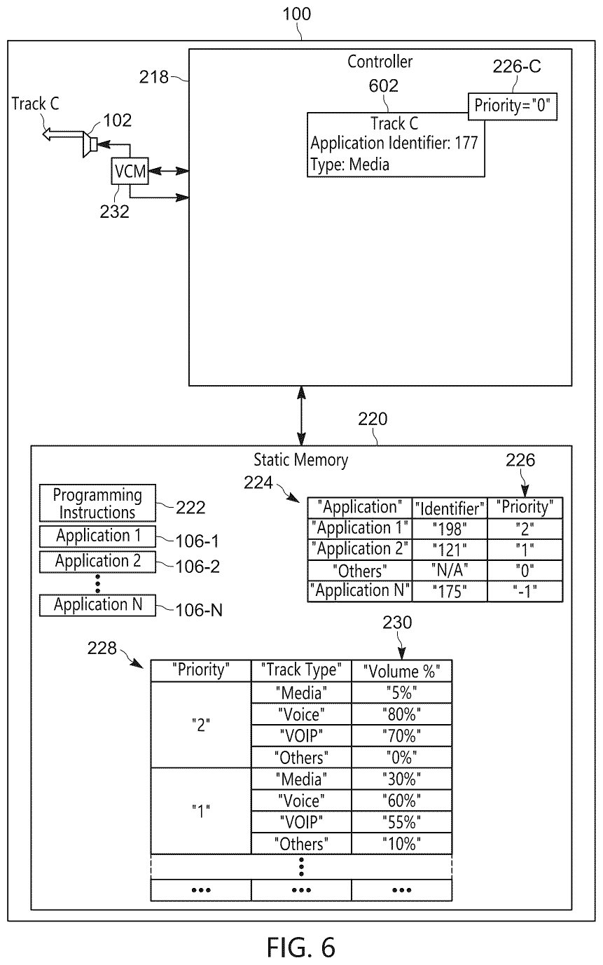

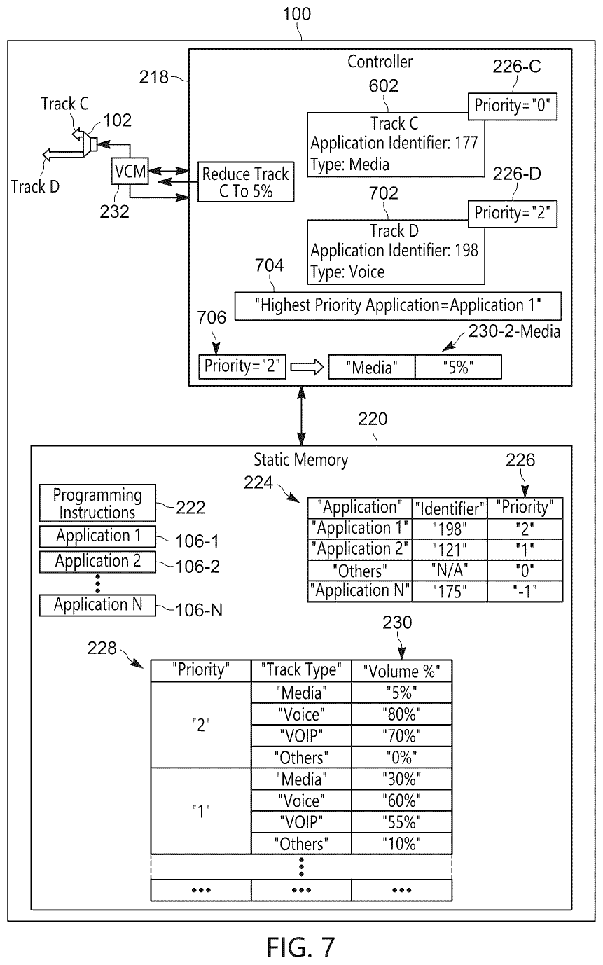

Put another way, when a given track is played at the block 306, an associated priority 226 of the given track may be determined by determining a respective priority 226 of the application 106 playing the given track. Indeed, respective priorities 226 of all the tracks currently being played may be determined (e.g., when played and/or at a time a new given track is played). Examples of this aspect are described with respect to FIG. 4, FIG. 5, FIG. 6 and FIG. 7.

Regardless, determining the associated volume control policy 230 of the block 308 may be based on the respective priorities 226 as determined with respect to the tracks.

Furthermore, controlling of the respective volume of the respective tracks presently being played by the applications 106, different from the highest priority application 106, may occur via the volume control module 232, which is understood to be different from the applications 106 configured to play the tracks.

The process 300 may include any other suitable features.

For example, the application 106 playing the given track may be different from the highest priority application 106 that is presently playing the respective track, such that the respective volume of the given track is controlled based on: the associated volume control policy 230 associated with the respective priority 226 of the highest priority application 106; and a track-type of the given track.

Alternatively, the application 106, playing the given track, may comprise the highest priority application 106, and the given track may comprise the respective track, such that a current volume of the given track is maintained, and the respective volume of respective tracks, presently being played by other applications 106, is controlled based on: the associated volume control policy 230 associated with the respective priority 226 of the highest priority application 106; and respective track-types of the respective tracks.

Regardless, tracks of applications 106 that are of lower priority 226 than the highest priority application 106 may be reduced according to the associated volume control policy 230 of the highest priority application 106 so as to not mask, obscure, override and/or interfere with a track of the highest priority application 106 being played at the speaker 102.

In particular, when a track comprises a voice stream of a highest priority mission-critical application 106, tracks of other applications 106 are reduced so as to not obscure and/or interfere with the voice stream played at the speaker 102.

Furthermore, as depicted, the process 300 may repeat from the block 306 (e.g., after the block 310) so that when a new given track is played by an application 106, the blocks 308, 310 repeat.

For example, in a first implementation of the blocks 306, 308, 310, the highest priority application 106 currently playing a track may not be the application 106 assigned the highest priority 226. As such, tracks of lower priority applications 106 are controlled according to the respective volume control policies 230 of the highest priority application 106 currently playing a track that is different from the application 106 assigned the highest priority 226.

However, on a second implementation of the blocks 306, 308, 310, the highest priority application 106 currently playing a track may change to the application 106 assigned the highest priority 226. The volumes tracks of lower priority applications 106, including the application 106 that was the highest priority application 106 in the first implementation the blocks 306, 308, 310, are now controlled according to the respective volume control policies 230 of the application 106 assigned the highest priority 226.

Hence, for example, when a voice stream is received at a mission-critical application 106 assigned the highest priority 226, track of other applications 106 are reduced so as to not mask, obscure, override and/or interfere the voice stream played at the speaker 102. Such control occurs regardless of whether the mission-critical application 106 was playing a track before other, lower priority applications 106 played a track, or whether the mission-critical application 106 plays a track while other, lower priority applications 106 are playing tracks.

It is further understood that the blocks 302, 304, and the like, may be implemented at any given time, including, but not limited to, while other blocks of the process 300 are being implemented, and/or that implementation of the blocks 302, 304 may be repeated at any given time, for example, when a new application 106 is installed and/or when an operator of the device 100 edits the respective priorities 226 and/or the respective volume control policies 230.

It is yet further understood that a volume control policy 230 of a highest priority application 106 may be changed while the highest priority application 106 is playing a track, and such changes to the volume control policy 230 may be implemented while the highest priority application 106 is playing a track. Put another way, an operator of the device 100, may change a volume control policy 230 to immediately reduce or increase volume of a track presently being played by an application 106 that is not the highest priority application 106.

Attention is next directed to FIG. 4, FIG. 5, FIG. 6 and FIG. 7, that depict aspects of the process 300. FIG. 4, FIG. 5, FIG. 6 and FIG. 7, are substantially similar to FIG. 2 with like components having like numbers; while, for simplicity, certain components of the device 100 are omitted in FIG. 4, FIG. 5, FIG. 6 and FIG. 7 (e.g., the communication interface 202 and components of the processing component 204 other than the controller 218), such components are nonetheless understood to be present.

It is further understood, in the following discussion, that the blocks 302, 304 of the process 300 have been implemented such that the respective priorities 226 and/or the respective volume control policies 230 are populated. Hence, at least FIG. 1 represents an implementation of the blocks 302, 304.

Attention is next directed to FIG. 4, in which it is understood that a Track A is being played at the speaker 102. As depicted, the device 100 may generate track information 402 for Track A, which indicates that an application 106 identified by an identifier “198” has generated Track A, and that Track A is a track type of “Voice”. From at least the identifier “198”, and the priority database 224, the device 100 may determine that the first application 106-1 identified by “198” generated Track A, and hence Track A is assigned a respective priority 226-A of “2” (e.g., the respective priority 226 of the first application 106-1).

Also depicted in FIG. 4, Track A is being played by the speaker 102, and a length of an arrow (e.g., labelled “Track A” in FIG. 4) emitted from the speaker 102 indicates a maximum volume of Track A.

Attention is next directed to FIG. 5, which is understood to follow in time from FIG. 4.

In particular, in FIG. 5, it is understood that Track A continues to play at the speaker 102, but a new Track B has also started playing (e.g., a “YES” decision at the block 306 of the process 300), as indicated by track information 502 for Track B. The track information 502 indicates that an application 106 identified by an identifier “121” has generated Track B, and that Track B is a track type of “VOIP”. From at least the identifier “121”, and the priority database 224, the device 100 may determine that the second application 106-2 identified by “121” generated Track B, and hence Track B is assigned a respective priority 226-B of “1” (e.g., the respective priority 226 of the second application 106-2).

As also depicted in FIG. 5, as indicated at a reference number 504, the device 100 determines from the priorities 226-A, 226-B that the highest priority application 106 presently playing a track is the first application 106-1 (e.g., “Highest Priority Application=Application 1”). As indicated at a reference number 506, the device 100 further determines, from the respective priority 226-A of the highest priority application 106-1 that is presently playing a respective track (e.g., the first application 106-1 playing Track A), that an associated volume control policy 230-2-VOIP for a “VOIP” track comprises reducing the “VOIP” track to “70%” of a maximum volume. Indeed, the determinations shown at the reference numbers 504, 506 are understood to show an example of the block 308 of the process 300.

Having determined that the associated volume control policy 230-2-VOIP of a “VOIP” track is to reduce the track to “70%” of a maximum volume, the device 100 controls (e.g., at the block 310 of the process 300) the speaker 102 to reduce VOIP Track B to “70%” of a maximum volume. For example, as depicted, the controller 218 provides a command to the VCM 232 to “Reduce Track B To 70%”. Presuming a maximum volume of both Track A and Track B are the same and/or similar, the arrow representing Track B (e.g., as depicted at the speaker 102), is understood to be “70%” of the length of the arrow representing Track A, indicating that Track B is reduced to “70%” of the volume of Track B.

Hence, presuming Track A is voice stream from a mission-critical application 106-1, reduction of the volume of VOIP Track B to “70%” of a maximum volume may assist with Track B not masking, obscuring overriding and/or interfering with the voice stream of Track A.

Attention is next directed to FIG. 6, in which it is understood that a Track C is being played at the speaker 102. It is further understood in FIG. 6 that neither Track A nor Track B is playing, and hence it is understood that the example of FIG. 6 occurs at a time different from the example of FIG. 4 and FIG. 5.

As depicted, the device 100 may generate track information 602 for Track C, which indicates that an application 106 identified by an identifier “177” has generated Track C, and that Track C is a track type of “Media”. From at least the identifier “177”, and the priority database 224, the device 100 may determine that an “Other” application 106 identified by “177” generated Track C, and hence Track C is assigned a respective priority 226-C of “0” (e.g., the respective priority 226 of the other applications 106). Put another way, as the identifier “177” does not appear in the priority database 224, the application 106 identified by “177” is classified as an “Other” application 106.

Also depicted in FIG. 6 is Track C being played by the speaker 102, in which a length of an arrow (e.g., labelled “Track C” in FIG. 6) emitted from the speaker 102 indicates a maximum volume of Track C.

Attention is next directed to FIG. 7, which is understood to follow in time from FIG. 6.

In particular, in FIG. 7, it is understood that Track C continues to play, but a new Track D has also started playing (e.g., a “YES” decision at the block 306 of the process 300), as indicated by track information 702 for Track D. An arrow labelled Track D indicates a maximum volume of Track D.

The track information 702 indicates that an application 106 identified by an identifier “198” has generated Track D, and that Track D is a track type of “Voice”. From at least the identifier “198”, and the priority database 224, the device 100 may determine that the first application 106-1 identified by “198” generated Track D, and hence Track D is assigned a respective priority 226-D of “2” (e.g., the respective priority 226 of the first application 106-1).

As also depicted in FIG. 7, as indicated at a reference number 704, the device 100 determines from the priorities 226-C, 226-D that the highest priority application 106 presently playing a track is the first application 106-1 (e.g., “Highest Priority Application=Application 1”). As indicated at a reference number 706, the device 100 further determines, from a respective priority 226-D of the highest priority application 106-1 that is presently playing a respective track, that an associated volume control policy 230-2-Media for a “Media” track comprises reducing the “Media” track to “5%” of a maximum volume. Indeed, the determinations shown at the reference numbers 704, 706 are understood to show an example of the block 308 of the process 300.

Having determined that the associated volume control policy 230-2-Media of a “Media” track is reduce the track to “5%” of a maximum volume, the device 100 controls (e.g., at the block 310 of the process 300) the speaker 102 to reduce Media Track C to 5% of a maximum volume. For example, as depicted, the controller 218 provides a command to the VCM 232 to “Reduce Track C To 5%”.

Indeed, comparing the arrows labelled Track C in FIG. 6 and FIG. 7, the arrow representing Track C in FIG. 7 is understood to be 5% of the length of the arrow representing Track C in FIG. 6, indicating that Track C is reduced to 5% of a maximum volume.

Hence, the examples shown in the combination of FIG. 4 and FIG. 5, and the combination of FIG. 6 and FIG. 7, illustrate that the process 300 results in a reduction of volume of tracks being played at the speaker 102, by applications 106 that are not a highest priority application 106. Such examples also illustrate that control of such volumes may occur on a per track-type basis for all applications 106 that are not a highest priority application 106, and not simply as a universal control of all tracks of all applications 106.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot control volume of tracks at a speaker on a per-track-basis, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
maintaining, via a computing device, respective priorities of applications configured to play tracks;
maintaining, via the computing device, volume control policies of volumes associated with different track types playable by the applications, the volume control policies associated with the respective priorities of the applications; and
when a given application plays a given track:
determining, via the computing device, an associated volume control policy associated with a respective priority of a highest priority application that is presently playing a respective track; and
controlling, via the computing device, and via a speaker, respective volumes of any respective tracks presently being played by applications different from the highest priority application, based on the associated volume control policy, the respective volumes controlled on a per track-type basis.

2. The method of claim 1, wherein determining the associated volume control policy associated with the respective priority of the highest priority application that is presently playing the respective track comprises:
determining respective priorities of the given track and any of the respective tracks being played by respective applications, the respective priorities of the given track and the respective tracks determined based on associated priorities of the given application and the respective applications,
wherein determining the associated volume control policy is based on the respective priorities as determined.

3. The method of claim 1, wherein the given application playing the given track is different from the highest priority application that is presently playing the respective track, such that a respective volume of the given track is controlled based on: the associated volume control policy associated with the respective priority of the highest priority application; and a track-type of the given track.

4. The method of claim 1, wherein the given application comprises the highest priority application, and the given track comprises the respective track, such that a current volume of the given track is maintained, and the respective volumes of the respective tracks, presently being played by other applications, is controlled based on:
the associated volume control policy associated with the respective priority of the highest priority application; and respective track-types of the respective tracks.

5. The method of claim 1, wherein the respective priorities of the applications implemented by the computing device are maintained in a priority database.

6. The method of claim 1, wherein the volume control policies are maintained in a volume database on a per-track-type basis.

7. The method of claim 1, wherein the controlling of the respective volumes of the respective tracks presently being played by the applications different from the highest priority application occurs via a volume control module different from the applications configured to play the tracks.

8. The method of claim 1, wherein maintaining the respective priorities of the applications comprises:
receiving, via an input device, the respective priorities of the applications; and
storing the respective priorities of the applications.

9. The method of claim 8, wherein maintaining the respective priorities of the applications further comprises:
assigning a given priority to the applications for which a respective priority is not received via the input device.

10. The method of claim 1, wherein maintaining the volume control policies of the volumes associated with the different track types playable by the applications comprises:
receiving, via an input device, respective relative volumes of the different track types; and
storing the respective relative volumes.

11. A computing device comprising:
a speaker;
a controller; and
a computer-readable storage medium having stored thereon program instructions that, when executed by the controller, causes the controller to perform a set of operations comprising:
maintaining respective priorities of applications configured to play tracks;
maintaining volume control policies of volumes associated with different track types playable by the applications, the volume control policies associated with the respective priorities of the applications; and
when a given application plays a given track:
determining an associated volume control policy associated with a respective priority of a highest priority application that is presently playing a respective track; and
controlling, via the speaker, respective volumes of any respective tracks presently being played by applications different from the highest priority application, based on the associated volume control policy, the respective volumes controlled on a per track-type basis.

12. The computing device of claim 11, wherein determining the associated volume control policy associated with the respective priority of the highest priority application that is presently playing the respective track comprises:
determining respective priorities of the given track and any of the respective tracks being played by respective applications, the respective priorities of the given track and the respective tracks determined based on associated priorities of the given application and the respective applications,
wherein determining the associated volume control policy is based on the respective priorities as determined.

13. The computing device of claim 11, wherein the given application playing the given track is different from the highest priority application that is presently playing the respective track, such that a respective volume of the given track is controlled based on: the associated volume control policy associated with the respective priority of the highest priority application; and a track-type of the given track.

14. The computing device of claim 11, wherein the given application comprises the highest priority application, and the given track comprises the respective track, such that a current volume of the given track is maintained, and the respective volumes of the respective tracks, presently being played by other applications, is controlled based on: the associated volume control policy associated with the respective priority of the highest priority application; and respective track-types of the respective tracks.

15. The computing device of claim 11, wherein the respective priorities of the applications implemented by the computing device are maintained in a priority database.

16. The computing device of claim 11, wherein the volume control policies are maintained in a volume database on a per-track-type basis.

17. The computing device of claim 11, wherein the controlling of the respective volumes of the respective tracks presently being played by the applications different from the highest priority application occurs via a volume control module different from the applications configured to play the tracks.

18. The computing device of claim 11, wherein maintaining the respective priorities of the applications comprises:
receiving, via an input device, the respective priorities of the applications; and
storing the respective priorities of the applications.

19. The computing device of claim 18, wherein maintaining the respective priorities of the applications further comprises:
assigning a given priority to the applications for which a respective priority is not received via the input device.

20. The computing device of claim 11, wherein maintaining the volume control policies of the volumes associated with the different track types playable by the applications comprises:
receiving, via an input device, respective relative volumes of the different track types; and
storing the respective relative volumes.
